(19) United States
(12) Patent Application Publication
(10) Pub. No.: US 2016/0199993 A1
(43) Pub. Date: Jul. 14, 2016

(54) BOLT CUTTER WITH A PLURALITY OF ATTACHMENTS FOR USE DURING INSTALLATION OR REPAIR OF A TOILET

(71) Applicant: JB Watts LLC, Forest Hill, MD (US)

(72) Inventor: John Watts, Forest Hill, MD (US)

(21) Appl. No.: 14/594,092

(22) Filed: Jan. 10, 2015

(51) Int. Cl. B26B 25/00; B25B 13/04; B25F 1/02

(52) U.S. Cl. CPC B26B 25/00; B25F 1/02; B25B 13/04

(57) ABSTRACT

A tool for trimming a bolt protruding through a nut includes a housing, a motor, a cutting wheel, and a wrench attachment. The cutting wheel is disposed within a first plane and is disposed at a first longitudinal position. The wrench attachment is disposed within a second plane spaced from the first plane. A wrench head of the wrench attachment is disposed at a second longitudinal position that is further away from the housing than the first longitudinal position such that the wrench head is longitudinally offset from the cutting wheel. The cutting wheel is configured to be longitudinally moved relative to the wrench attachment toward the wrench head. The tool may also include a bumper attachment that is interchangeable with the wrench attachment for use when cutting a frozen nut.

### FIELD OF THE INVENTION

In general, the invention relates to hand-held power tools and more particularly, to hand-held power tools for cutting or trimming a bolt.

### BACKGROUND OF THE INVENTION

During toilet installation and/or replacement, anchor or “johnny” bolts are used to secure the toilet to the floor. Anchor bolts typically come in an extended length to accommodate a variety of possible depths between a toilet base and the floor. Thus, the anchor bolts must be trimmed after they are tightened with nuts so that a cosmetic cap or cover may be placed over the bolts. Trimming the anchor bolts is not an easy task because of the limited or constrained space in which a toilet is often installed. The limited space sometimes results in the installer spending an extended amount of time trying to trim the bolts with a saw or other tool that he cannot easily move in the constrained space. Furthermore, the tool can strike the toilet base or a nearby structure within the surrounding area such as a wall or cabinet, leaving scratches, chips, cracks, or other damage. In addition, the task of trimming anchor bolts may cause pain or injury in the installer since the process of hacking away at the anchor bolts involves physically-demanding labor in an uncomfortable or awkward position while in a constrained area.

It is therefore an objective of the present invention to provide improved means for trimming anchor bolts of a toilet and for cutting nuts and/or bolts that cannot be removed by conventional means.

### BRIEF SUMMARY OF THE INVENTION

Embodiments hereof relate to an apparatus for trimming a bolt protruding through a nut. The apparatus includes a housing, a motor disposed within the housing, a cutting wheel for trimming the bolt, and a wrench attachment removably coupled to the housing. The housing includes a longitudinal axis. The cutting wheel is disposed external to the housing and is coupled to the motor. The cutting wheel is disposed within a first plane spaced from the longitudinal axis of the housing and is disposed at a first longitudinal position. When coupled to the housing, the wrench attachment is disposed within a second plane that is farther from the longitudinal axis of the housing than the first plane. In addition, when coupled to the housing, a wrench head of the wrench attachment is disposed at a second longitudinal position that is further away from the housing than the first longitudinal position such that the wrench head of the wrench attachment is longitudinally offset from the cutting wheel. When the wrench attachment is coupled to the housing, the cutting wheel is configured to be longitudinally moved relative to the wrench attachment toward the wrench head.

According to another embodiment hereof, the apparatus includes a housing, a motor disposed within the housing, a cutting wheel for trimming the bolt, a wrench attachment removably coupled to the housing, and a bumper attachment removably coupled to the housing. The housing includes a longitudinal axis. The cutting wheel is disposed external to the housing and is coupled to the motor. The cutting wheel is disposed within a first plane spaced from the longitudinal axis of the housing and is disposed at a first longitudinal position. When coupled to the housing, the wrench attachment is disposed within a second plane that is farther from the longitudinal axis of the housing than the first plane. In addition, when coupled to the housing, a wrench head of the wrench attachment is disposed at a second longitudinal position that is further away from the housing than the first longitudinal position such that the wrench head of the wrench attachment is longitudinally offset from the cutting wheel. The bumper attachment includes a pad configured to abut against a base of a toilet. When coupled to the housing, the bumper attachment is disposed within the second plane that is farther from the longitudinal axis of the housing than the first plane and the pad of the bumper attachment is disposed at the first longitudinal position. When one of the wrench attachment or the bumper attachment is coupled to the housing, the cutting wheel is configured to be longitudinally moved relative to the wrench attachment or the bumper attachment coupled to the housing.

According to another embodiment hereof, the apparatus includes a housing, a motor disposed within the housing, a cutting wheel for trimming the bolt, and a wrench attachment removably coupled to the housing. The housing includes a longitudinal axis. The cutting wheel is disposed external to the housing and is coupled to the motor. The cutting wheel is disposed within a first plane spaced from the longitudinal axis of the housing and is disposed at a first longitudinal position. When coupled to the housing, the wrench attachment is disposed within a second plane that is farther from the longitudinal axis of the housing than the first plane. In addition, when coupled to the housing, a wrench head of the wrench attachment is disposed at a second longitudinal position that is further away from the housing than the first longitudinal position such that the wrench head of the wrench attachment is longitudinally offset from the cutting wheel. When coupled to the housing, a shaft of the wrench attachment is disposed within a slot located within an attachment receiving portion of the housing. The slot is sized to receive the shaft of the wrench attachment and a spring is disposed within the slot. When the wrench attachment is coupled to the housing, the cutting wheel is configured to be longitudinally moved relative to the wrench attachment toward the wrench head by sliding the housing over the shaft of the wrench attachment, thereby compressing the spring. The spring is configured to return the cutting wheel to the first longitudinal position when no force is applied to the apparatus.

### BRIEF DESCRIPTION OF DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of a tool according to an embodiment hereof, wherein the tool includes a cutting wheel.

FIG. 2 is a perspective view of a wrench attachment for insertion within a slot of a housing of the tool of FIG. 1.

FIG. 3 is a perspective view of a bumper attachment for insertion within the slot of the housing of the tool of FIG. 1.

FIG. 4 is a perspective view of the tool of FIG. 1, wherein a portion of the housing is removed to illustrate the internal components thereof

FIG. 5 is a cross-sectional view of the tool of FIG. 1 taken along line A-A of FIG. 1.

FIG. 6 is an exploded perspective view of the tool of FIG. 1.

FIG. 7 is a perspective view of the tool of FIG. 1 with the wrench attachment of FIG. 2 inserted within the slot of the housing of the tool, wherein the cutting wheel is in a first longitudinal position.

FIG. 8 is a cross-sectional view of the tool and wrench attachment taken along line A-A of FIG. 7, wherein the cutting wheel is in the first longitudinal position.

FIG. 9 is a cross-sectional view of the tool and wrench attachment taken along line A-A of FIG. 7, wherein the cutting wheel is longitudinally advanced relative to the wrench attachment.

FIG. 10A illustrates a first step of a method of use of the tool of FIG. 1 with the wrench attachment of FIG. 2, wherein the wrench attachment is utilized to tighten a nut around a bolt.

FIG. 10B illustrates a second step of a method of use of the tool of FIG. 1 with the wrench attachment of FIG. 2, wherein the cutting wheel is longitudinally advanced from its first longitudinal position in order to trim or cut the bolt above the nut.

FIG. 10C illustrates a third step of a method of use of the tool of FIG. 1 with the wrench attachment of FIG. 2, wherein the cutting wheel returns to its first longitudinal position after the bolt is trimmed.

FIG. 11 is a perspective view of the tool of FIG. 1 with the bumper attachment of FIG. 3 inserted within the slot of the housing of the tool, wherein the cutting wheel is in its first longitudinal position.

FIG. 12 is a cross-sectional view of the tool and bumper attachment taken along line A-A of FIG. 11, wherein the cutting wheel is in its first longitudinal position.

FIG. 13 is a cross-sectional view of the tool and bumper attachment taken along line A-A of FIG. 11, wherein the cutting wheel is longitudinally advanced relative to the bumper attachment.

FIG. 14 illustrates a method of use of the tool of FIG. 1 with the bumper attachment of FIG. 3, wherein the cutting wheel is longitudinally advanced from its first longitudinal position in order to cut a frozen nut and/or bolt.

FIG. 15 is a sectional view of a tool according to another embodiment hereof, wherein the tool includes an internal slide assembly for advancing a cutting wheel.

### DETAILED DESCRIPTION OF THE INVENTION

Specific embodiments of the present invention are now described with reference to the figures, wherein like reference numbers indicate identical or functionally similar elements. The following detailed description is merely exemplary in nature and is not intended to limit the invention or the application and uses of the invention. Although the invention is described in the context of installation, replacement, and/or repair of a toilet or water closet, the invention may also be used as a bolt trimmer in other applications where it is deemed useful. Furthermore, there is no intention to be bound by any expressed or implied theory presented in the preceding technical field, background, brief summary or the following detailed description.

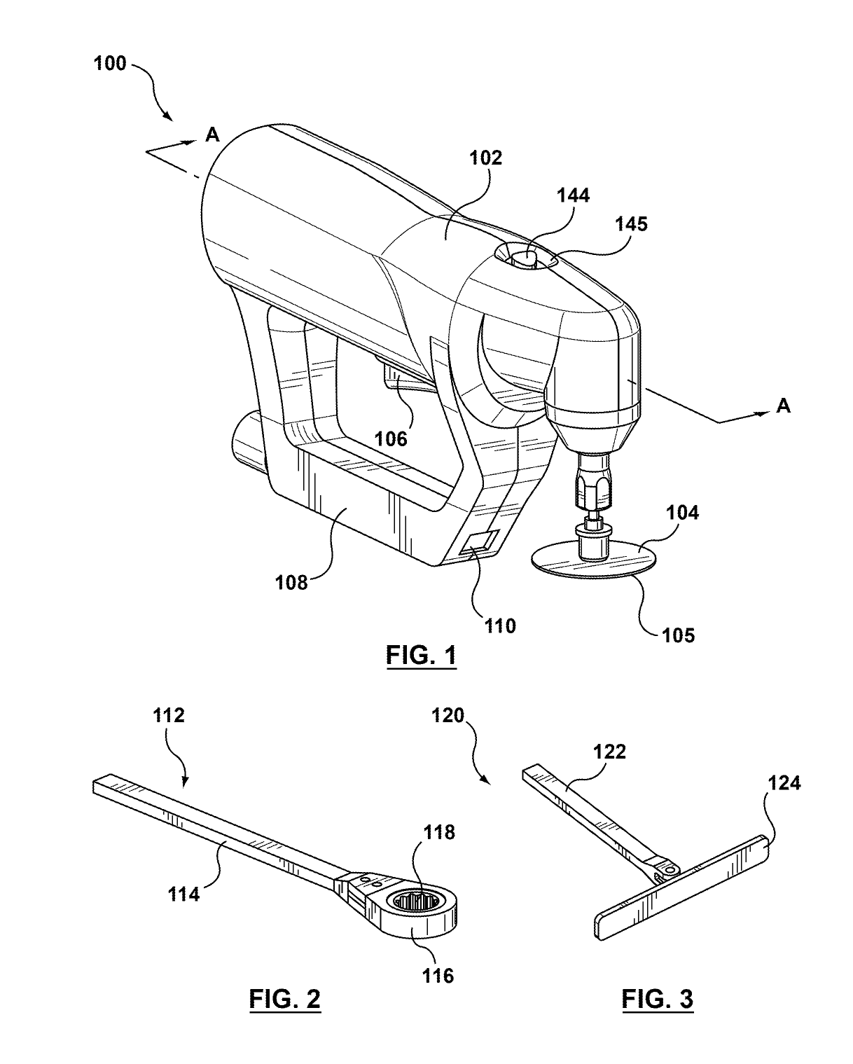

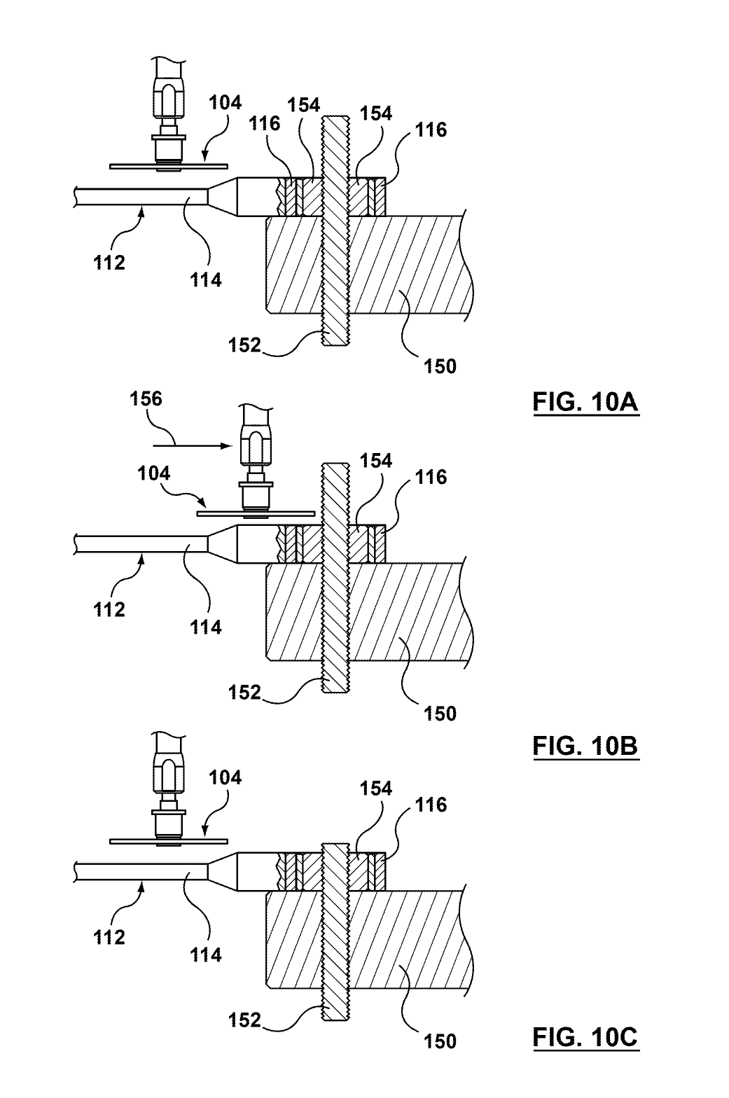

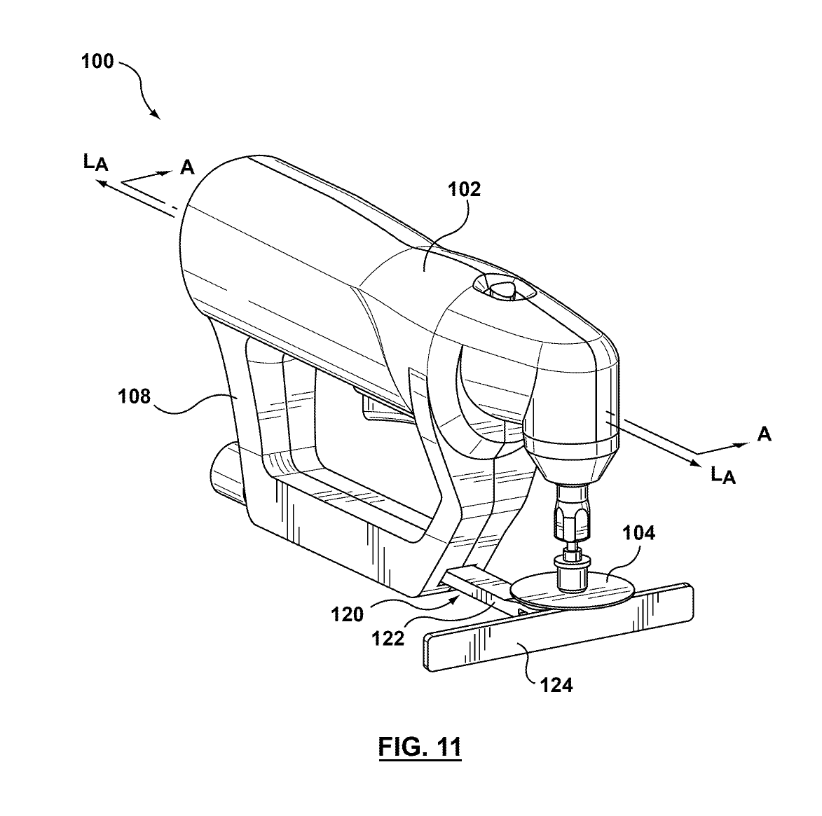

With reference to FIGS. 1-3, embodiments hereof relate to a hand-held power tool 100 that functions as both a bolt cutter and a wrench. Tool 100 is a cutting tool which includes a plurality of removable and interchangeable attachments. More particularly, tool 100 includes a cutting wheel 104 for trimming a bolt, a wrench attachment 112 configured to be selectively inserted within housing 102 of tool 100, and a bumper attachment 120 configured to be selectively inserted within housing 102 of tool 100. FIG. 1 is a perspective view of tool 100, while FIG. 2 is a perspective view of wrench attachment 112 and FIG. 3 is a perspective view of bumper attachment 120. Cutting wheel 104 includes a cutting edge 105 that extends around the circumference thereof. As will be explained in more detail herein with respect to FIGS. 10A-10C, in an embodiment hereof, wrench attachment 112 is used when installing a toilet or water closet. Wrench attachment 112 includes a shaft 114 and a wrench head 116 attached to an end of shaft 114. Wrench head 116 defines an opening 118 that is sized to receive and tighten a nut (not shown in FIG. 2) onto an anchor bolt (not shown in FIG. 2) which retains a toilet to the floor. Although only one wrench attachment is shown in FIG. 2, it will be understood in the art that tool 100 may include various wrench attachments with different sized wrench head openings configured to receive and tighten different sized nuts. Thus, tool 100 can accommodate various nut sizes by detaching a first wrench attachment that is not the proper size for the nut b e in g tightened from tool 100 and installing a second wrench attachment that is the proper size for the nut being tightened. Shaft 114 of wrench attachment 112 is configured to be inserted within a slot 110 of a housing 102 of tool 100. Wrench head 116 is configured to be positioned over the nut and the nut may be tightened via wrench head 116, and then cutting wheel 104 is longitudinally advanced relative to wrench attachment 112 in order to cut or trim the length of the bolt that protrudes or extends above the nut.

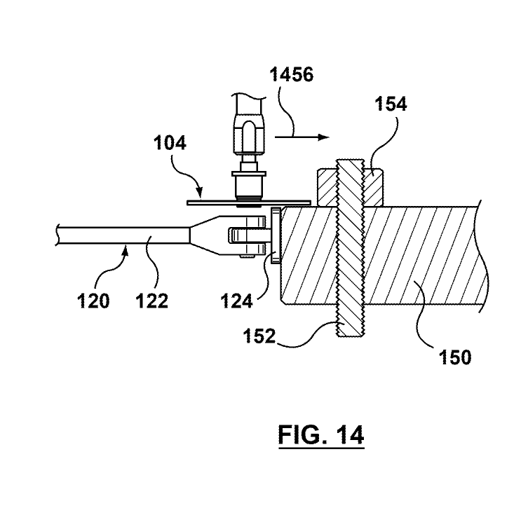

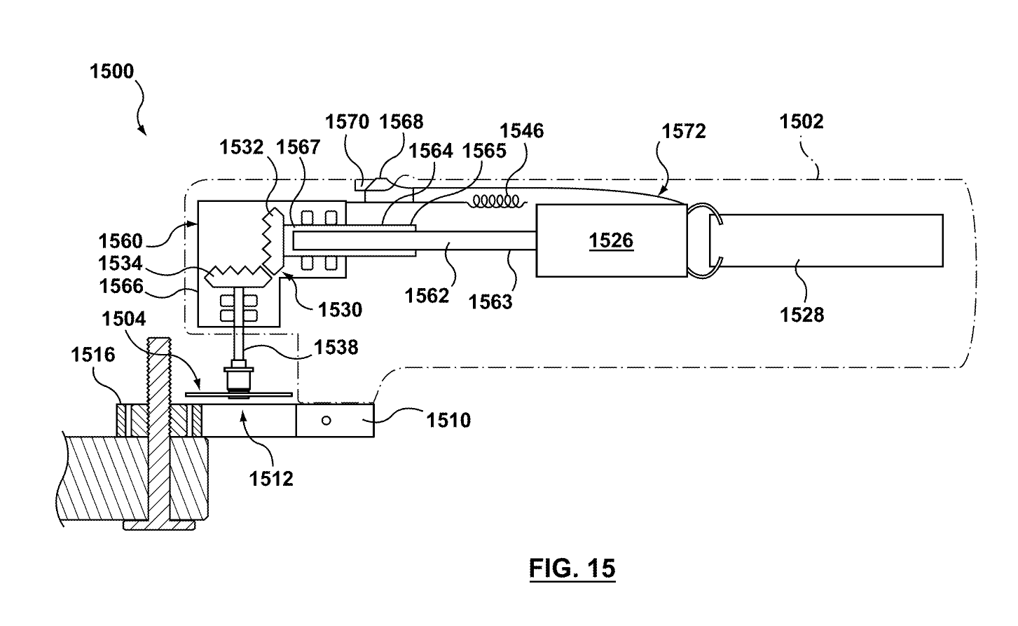

As will be explained in more detail herein with respect to FIG. 14, in an embodiment hereof, bumper attachment 120 is used when removing or repairing a toilet or water closet if the nut cannot be removed due to damaged threads, rusting, or any other reason. Such a nut is herein referred to as a frozen nut. Bumper attachment 120 includes a shaft 122 and a pad 124 attached to an end of shaft 122. Shaft 122 of bumper attachment 120 is configured to be inserted within slot 110 of housing 102 of tool 100. Pad 124 is configured to abut or press against the side of the toilet for stabilization while cutting wheel 104 is longitudinally advanced relative to bumper attachment 120 in order to cut the frozen nut and bolt. Pad 124 may be formed from a relatively soft material that does not damage the toilet when pressed against it, and in an embodiment hereof, pad 124 includes a relatively tacky or non-slip material that holds bumper attachment 120 in place against the toilet during use. In another embodiment pad 124 may be formed from a relatively harder material and include a softer material attached to a face thereof. In a non-limiting example, pad 124 may be include a metal base material and include a neoprene rubber cushion with single side adhesive to couple the cushion to the base material.

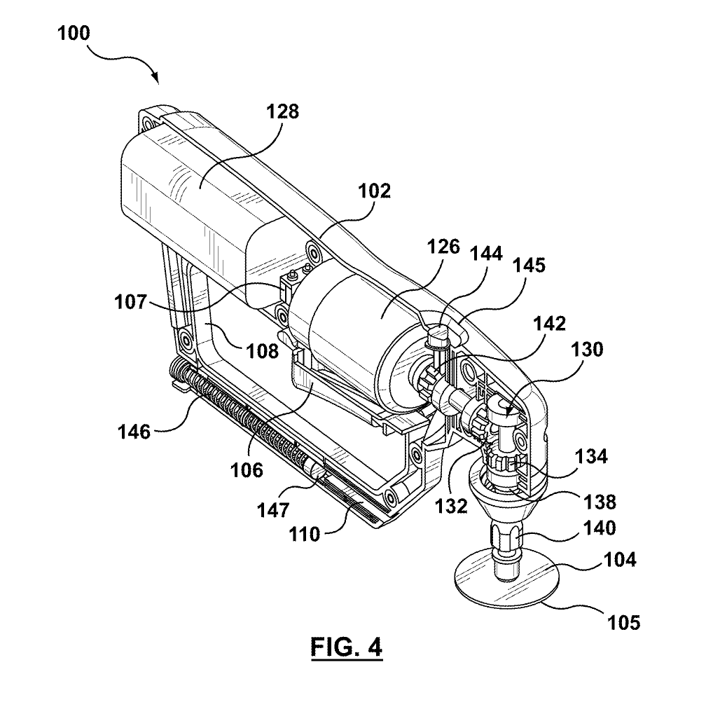

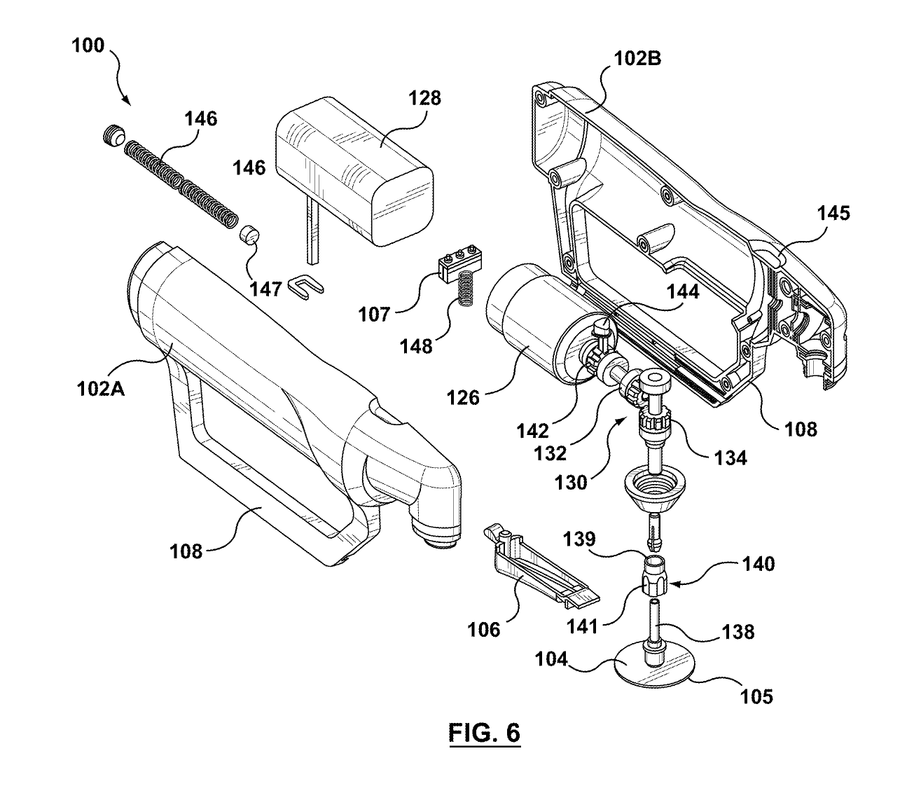

Tool 100 will now be described in more detail. Tool 100 includes housing 102 having an attachment receiving portion 108. Housing 102 is formed from two opposing halves, 102A and 102B (shown in FIG. 6), that are mirror images of each other and are collectively referred to herein as housing 102. In an embodiment hereof, tool 100 has a length ranging between 8 and 12 inches, a depth ranging between 1 and 2 inches, and a height ranging between 3 and 6 inches. Slot 110 is positioned within attachment receiving portion 108 of housing 102, and is configured to and sized to receive shaft 114 of wrench attachment 112 and/or shaft 122 of bumper attachment 120. A coil or spring 146 (shown in FIGS. 4-6) is disposed within slot 110 as will be described in more detail herein.

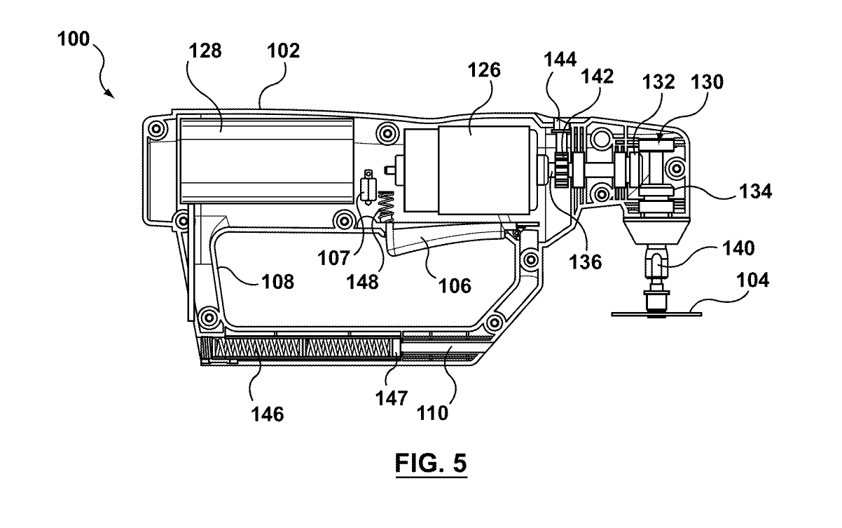

Housing 102 encloses the internal components of tool 100. More particularly, with reference to FIGS. 4-6, a motor 126, a power source 128 and a gear assembly 130 are each disposed within housing 102. FIG. 4 is a perspective view of tool 100, with a portion of housing 102 removed to illustrate the internal components thereof, while FIG. 5 is a cross-sectional view of tool 100 and FIG. 6 is an exploded perspective view of tool 100. In an embodiment hereof, power source 128 is a rechargeable, removable battery. Power source 128 is coupled to motor 126 in order to provide power thereto. Motor 126 is coupled to gear assembly 130 via a first shaft 136 (best shown in the cross-sectional view of FIG. 5), and gear assembly 130 is coupled to cutting wheel 104 via a second shaft 138. More particularly, gear assembly 130 includes a first gear 132 coupled to motor 126 via first shaft 136 and a second gear 134 coupled to cutting wheel 104 via second shaft 138. First and second gears 132, 134 are disposed at a 90 degree angle relative to each other and are configured to transfer the spinning motion of motor 126 to cutting wheel 104 such that motor 126 drives or spins cutting wheel 104. A coupler 140, which is external to housing 102, may couple second shaft 138 to cutting wheel 104. Coupler 140 may include an inner collet 139 (shown in the exploded view of FIG. 6) that fits or is received within an outer collet 141 (shown in the exploded view of FIG. 6).

Tool 100 also includes a trigger 106 for activating motor 126, which drives cutting wheel 104 as explained above. Trigger 106 extends outside of housing 102 in order to be accessible to a user, and trigger 106 is coupled to a trigger switch 107 which is housed within housing 102 and disposed between motor 126 and power source 128. Trigger switch 107 is electrically coupled to motor 126 and power source 128 as will be understood by one of ordinary skill in the art in order for trigger 106 to selectively engage motor 126 when manually pressed by a user. A coil or spring 148 is disposed adjacent to trigger 106. When trigger 106 is pressed by a user, trigger 106 pivots into housing 102 and spring 148 is compressed. When trigger 106 is released by the user, spring 148 returns to its relaxed or normal configuration in which it is no longer compressed and thereby pushes or springs trigger 106 away from housing 102. Stated another way, spring 148 functions to return trigger 106 to its non-pressed configuration when no force is applied to the trigger.

Tool 100 also includes a locking button 144 that extends through an opening 145 (best shown on FIG. 1) within housing 102. In an embodiment hereof, locking button 144 may be pressed in order to lock gear assembly 130 during replacement of cutting wheel 104. More particularly, a lock flower 142 is disposed over first shaft 136 that extends between motor 126 and first gear 132. In a first position, i.e., when in a nominal configuration in which no force is applied thereto, locking button 142 is disengaged from or is not coupled to lock flower 142 and thus allows rotation or spinning of first shaft 136. However, in a second position, i.e., when locking button 142 is pressed by a user, locking button 142 engages with or couples to lock flower 142 and prevents rotation of first shaft 136 as best shown in the cross-sectional view of FIG. 5. When a user replaces cutting wheel 104, the user presses locking button 142 so that coupler 140 may be loosened without causing gear assembly 130 to spin.

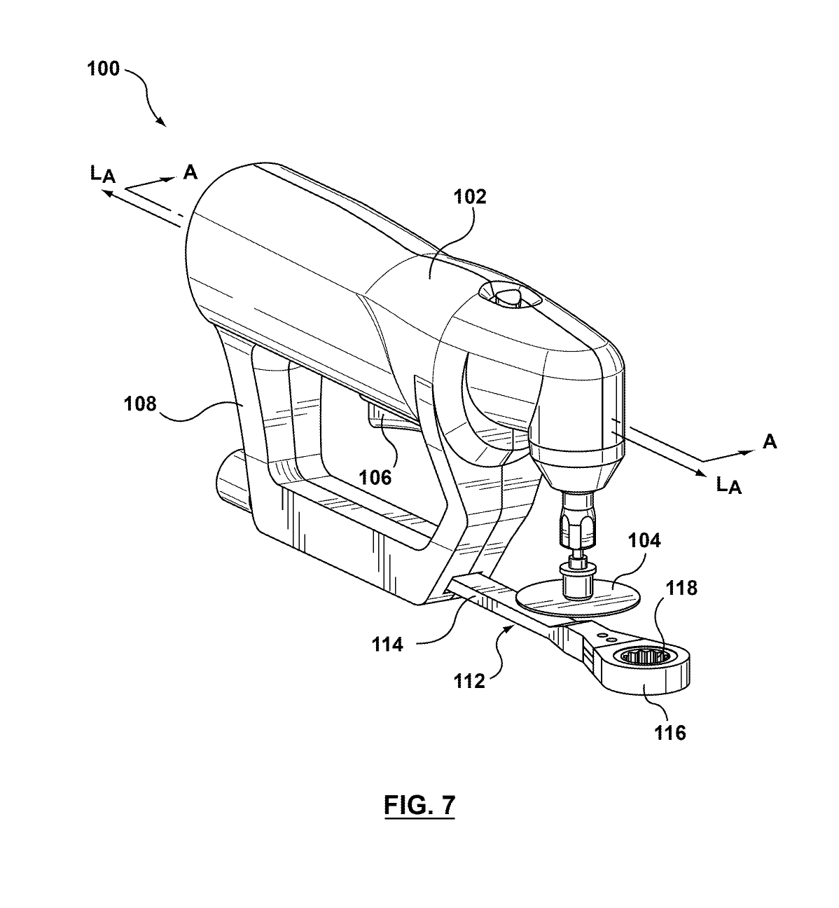

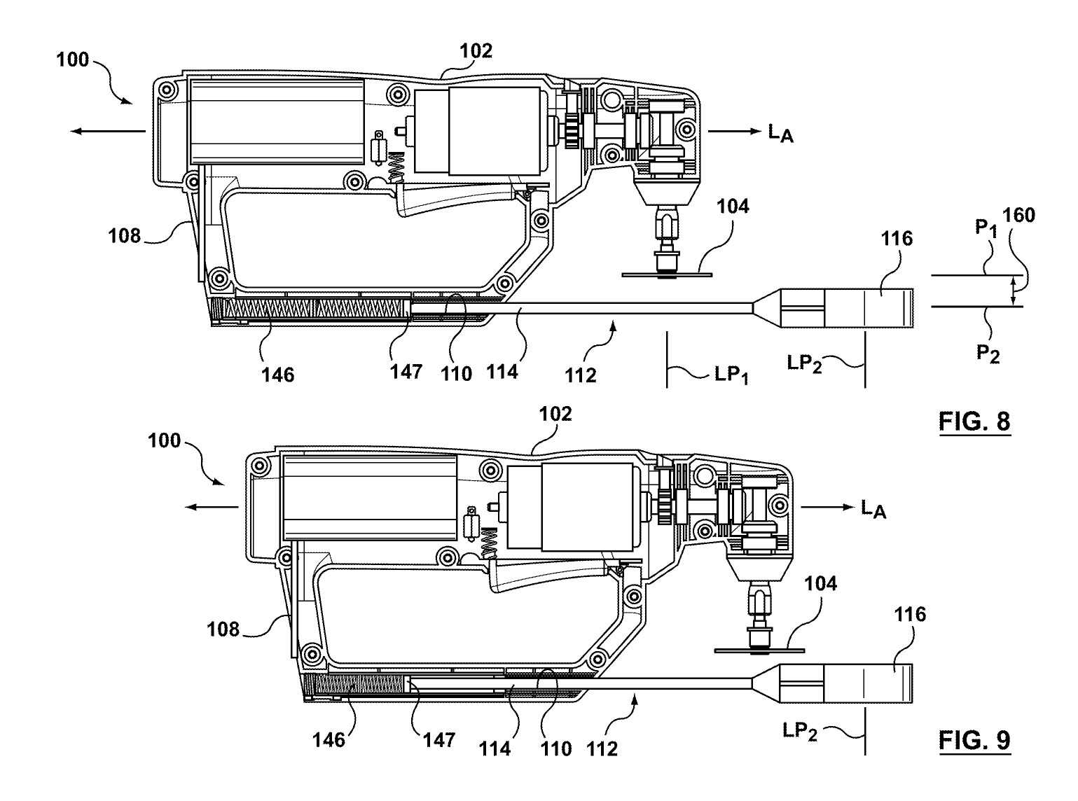

Turning now to FIGS. 7-9, operation of tool 100 with wrench attachment 112 inserted therein will be described. FIG. 7 is a perspective view of tool 100 with shaft 114 of wrench attachment 112 inserted within slot 110 of housing 102, while FIG. 8 is a cross-sectional view of tool 100 and wrench attachment 112 taken along line A-A of FIG. 7. Cutting wheel 104 is shown in its first longitudinal position in FIGS. 7-8, while FIG. 9 is a cross-sectional view of tool 100 and wrench attachment 112 taken along line A-A of FIG. 7 with cutting wheel 104 longitudinally advanced relative to wrench attachment 112. More particularly, housing 102 of tool 100 includes a longitudinal axis L_{A} and cutting wheel 104 is disposed within a first plane P₁. In an embodiment, first plane P₁ of cutting wheel 104 is spaced from or offset relative to longitudinal axis L_{A} of housing 102. Further, cutting wheel 104 is disposed at a first longitudinal position LP₁. As used herein, a longitudinal position of a component and a plane in which a component lies are determined by a centerline of the component.

When coupled to tool 100, wrench head 116 of wrench attachment 112 is disposed parallel to the longitudinal axis L_{A} of housing 102 at a second longitudinal position LP₂. Second longitudinal position LP₂ of wrench head 116 is further away from housing 102 than first longitudinal position LP₁ of cutting wheel 104. Stated another way, cutting wheel 104 is longitudinally offset from or recessed relative to wrench head 116 of wrench attachment 112 so that cutting wheel 104 does not interfere or inhibit tightening of a nut around an anchor bolt in a toilet installation example. In addition, when coupled to tool 100, wrench attachment 112 is disposed within a second plane P₂ that is spaced from first plane P₁ relative to longitudinal axis L_{A}, as indicated by a predetermined distance 160. Thus, second plane P₁ is farther from longitudinal axis L_{A} than first plane P₁. Stated another way, wrench head 116 of wrench attachment 112 is positioned below or under cutting wheel 104 relative to longitudinal axis L_{A}. In an embodiment, first and second planes P₁, P₂ are parallel planes. Predetermined distance 160 is selected or set such that cutting wheel 104 trims an anchor bolt to a predetermined height above the nut in a toilet installation example. Predetermined distance 160 is selected or set such that cutting wheel 104 is configured to be located just above the nut.

When it is desired to position cutting wheel 104 during operation, i.e., when it is desired to trim an anchor bolt to a predetermined height about the nut in a toilet installation example, cutting wheel 104 is longitudinally advanced or moved relative to wrench attachment 112. More particularly, tool 100 is configured to be moved along the longitudinal axis L_{A} toward wrench head 116 of wrench attachment 112 by sliding or translating tool 100 over shaft 114 of the wrench attachment. As tool 100 is moved along the longitudinal axis L_{A} toward wrench head 116, cutting wheel 104 is also moved in a longitudinal direction, parallel to the longitudinal axis L_{A}. In an embodiment, wrench attachment 112 remains substantially stationary due to wrench head 116 being disposed around a nut, and thus shaft 114 may be considered a rail or guide during the sliding movement of tool 100. During advancement, cutting wheel 104 remains disposed within first plane P₁ and is longitudinally advanced relative to wrench attachment 112. In an embodiment hereof, cutting wheel 104 is longitudinally advanced 2 inches relative to wrench attachment 112 but it will be understood by those of ordinary skill in the art that the distance or amount of advancement may vary according to application. For example, it may be desirable to advance cutting wheel 104 beyond or past second longitudinal position LP₂ of wrench head 116 in order to pass cutting wheel 104 completely through an anchor bolt. In another embodiment, it may be sufficient to advance cutting wheel 104 approximately to the second longitudinal position LP₂ of wrench head 116 in order to trim the anchor bolt. In an embodiment, the distance or amount of advancement of cutting wheel 104 is a user-controlled variable. Stated another way, a user controls the distance or length that the tool is moved over the wrench attachment.

As previously mentioned, spring 146 is disposed within slot 110 adjacent to shaft 114 of wrench attachment 112. Shaft 114 of wrench attachment 112 is removably coupled to spring 146 via a magnet 147 (best shown in the exploded view of FIG. 6) when wrench attachment 112 is inserted into slot 110. Magnet 147 is attached to spring 146 and is also housed or disposed within slot 110. Shaft 114 may be removable coupled to spring 146 by other mechanisms such as, but not limited to, clips, friction fit, snap-fit, and other mechanisms. Spring 146 is configured to return cutting wheel 104 to the first longitudinal position when no force is applied to tool 100. More particularly, as tool 100 is slid over or moved relative to shaft 114 in order to advance cutting wheel 104, spring 146 is compressed as shown in FIG. 9. When housing 102 is released by the user, spring 146 returns to its relaxed or normal configuration in which it is no longer compressed and thereby retracts tool 100 (and cutting wheel 104) backwards. Cutting wheel 104 is thus returned to its first longitudinal position in which it is disposed parallel to the longitudinal axis L_{A} of housing 102 at first longitudinal position LP₁.

FIGS. 10A-10C illustrate a method of using tool 100 having wrench attachment 112 inserted therein for trimming an anchor bolt 152 during installation of a toilet 150. FIG. 10A illustrates a first step of the method of use in which wrench head 116 is positioned over a nut 154 disposed around bolt 152. Nut 154 may be tightened around bolt 152 by rotation of wrench head 116 relative to nut 154. Cutting wheel 104 is in its first longitudinal position in which cutting wheel 104 is longitudinally offset from or recessed relative to wrench head 116 so that cutting wheel 104 does not interfere or inhibit tightening of nut 154 around bolt 152.

FIG. 10B illustrates a second step of the method of use in which cutting wheel 104 is longitudinally advanced or moved from its first longitudinal position in order to trim or cut bolt 152 just slightly above a top surface of nut 154. More particularly, once nut 154 is tightened as desired, trigger 106 is pressed to engage or activate the power to motor 126, causing cutting wheel 104 to spin. Tool 100 including cutting wheel 104 is then longitudinally advanced relative to wrench attachment 112 in order to cut or trim the length of bolt 152 that protrudes or extends above nut 154. Stated another way, while wrench head 116 is disposed over nut 154, tool 100 is slid over or moved relative to shaft 114 in order to advance cutting wheel 104 towards wrench head 116 and bolt 152. Cutting wheel 104 is longitudinally advanced until it cuts or trims bolt 152 at the proper height to allow for the installation of a cosmetic cap (not shown). Although the method of use described herein includes activating or engaging motor 126 prior to advancement to cutting wheel 104, it will be understood by one of ordinary skill in the art that cutting wheel 104 may be longitudinally advanced to a certain extent, i.e., advanced until cutting wheel 126 abuts against bolt 152, prior to activating or engaging motor 126 via trigger 106.

FIG. 10C illustrates a third step of the method of use in which cutting wheel 104 has returned to its first longitudinal position after bolt 152 is trimmed. More particularly, after bolt 152 is trimmed, the user removes the force applied to housing 102 and spring 146 of tool 100 is configured to retract tool 100 (and cutting wheel 104) backwards. Cutting wheel 104 is thus returned to its first longitudinal position in which cutting wheel 104 is longitudinally offset from or recessed relative to wrench head 116. If desired, a cosmetic cap (not shown) may then be installed over the trimmed bolt.

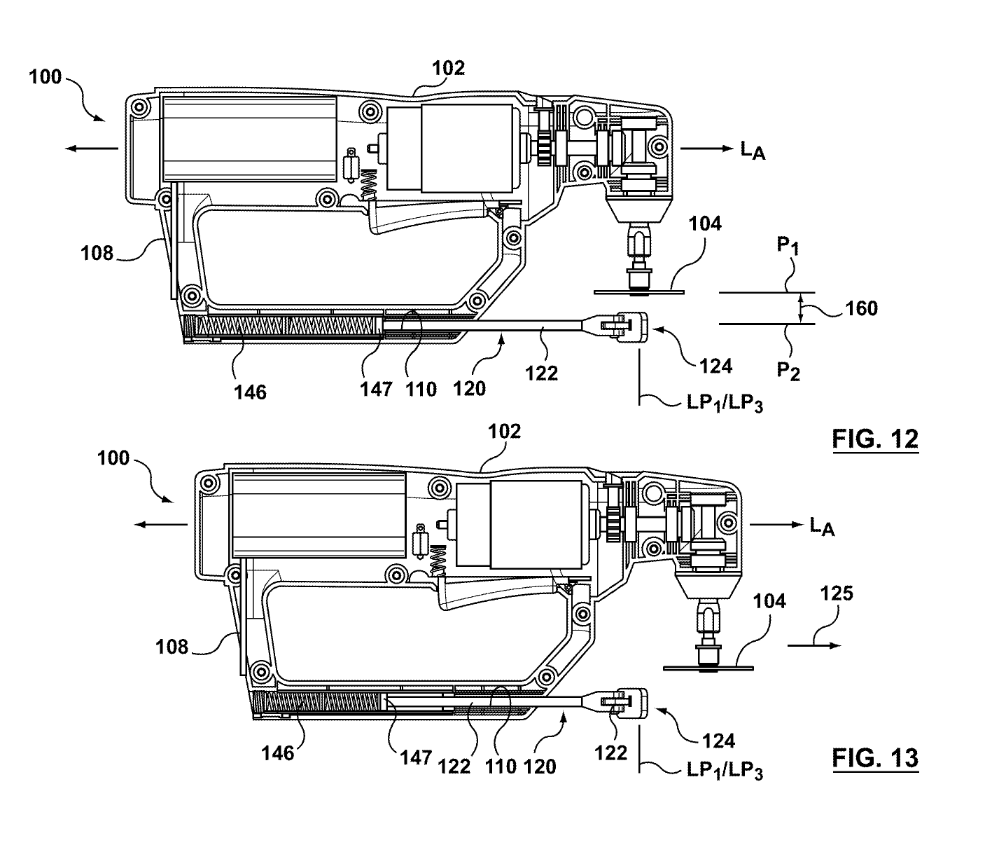

Turning now to FIGS. 11-13, operation of tool 100 with bumper attachment 120 inserted therein will be described. FIG. 11 is a perspective view of tool 100 with shaft 114 of bumper attachment 120 inserted within slot 110 of housing 102, while FIG. 12 is a cross-sectional view of tool 100 and bumper attachment 120 taken along line A-A of FIG. 11. Cutting wheel 104 is shown in its first longitudinal position in FIGS. 11-12, while FIG. 13 is a cross-sectional view of tool 100 and bumper attachment 120 taken along line A-A of FIG. 11 with cutting wheel 104 longitudinally advanced relative to bumper attachment 120. More particularly, cutting wheel 104 is disposed at a first longitudinal position LP₁ as described above with respect to FIGS. 7-8. Further, cutting wheel 104 is disposed within a first plane P₁ as described above with respect to FIGS. 7-8.

When coupled to tool 100, pad 124 of bumper attachment 120 is disposed parallel to the longitudinal axis L_{A} of housing 102 at a third longitudinal position LP₃. Third longitudinal position LP₃ of pad 124 is approximately equal to first longitudinal position LP₁ of cutting wheel 104. Stated another way, cutting wheel 104 is approximately longitudinally aligned with pad 124 of bumper attachment 120. As used herein, “approximately equal” and “approximately longitudinally aligned” includes that a front face of pad 124 is between 0 and 0.5 inches away from the central axis of cutting wheel 104. However, it will be understood by those of ordinary skill in the art that the third longitudinal position LP₃ of pad 124 may vary according to application. In addition, when coupled to tool 100, bumper attachment 120 is disposed within second plane P₂ that is spaced from first plane P₁ relative to longitudinal axis L_{A}, as indicated by predetermined distance 160. Thus, second plane P₂ is farther from longitudinal axis L_{A} than first plane P₁. Stated another way, pad 124 of bumper attachment 120 is positioned below or under cutting wheel 104 relative to longitudinal axis L_{A}.

When it is desired to position cutting wheel 104 during operation, i.e., when it is desired to cut a frozen nut in a toilet repair or removal example, cutting wheel 104 is longitudinally advanced or moved relative to bumper attachment 120. More particularly, tool 100 is configured to be moved along the longitudinal axis L_{A} away from pad 124 as indicated by directional arrow 125 by sliding or translating tool 100 over shaft 122 of bumper attachment 120. As tool 100 is moved along the longitudinal axis L_{A}, cutting wheel 104 is also moved in a longitudinal direction, parallel to the longitudinal axis L_{A}. In an embodiment, bumper attachment 120 remains substantially stationary due to pad 124 being abutted against or flush with a base of a toilet, and thus shaft 122 may be considered a rail or guide during the sliding movement of tool 100. During advancement, cutting wheel 104 remains disposed within first plane P₁ and is longitudinally advanced relative to bumper attachment 120. The distance or amount of advancement may vary according to application as described above with respect to wrench attachment 112.

As previously mentioned, spring 146 is disposed within slot 110 adjacent to shaft 122 of bumper attachment 120. Spring 146 is configured to return cutting wheel 104 to the first longitudinal position when no force is applied to tool 100. More particularly, as tool 100 is slid over or moved relative to shaft 122 in order to advance cutting wheel 104, spring 146 is compressed as shown in FIG. 13. When housing 102 is released by the user, spring 146 returns to its relaxed or normal configuration in which it is no longer compressed and thereby retracts tool 100 (and cutting wheel 104) backwards. Cutting wheel 104 is thus returned to its first longitudinal position in which it is disposed parallel to the longitudinal axis L_{A} of housing 102 at a first longitudinal position LP₁.

FIG. 14 illustrates a method of using tool 100 having bumper attachment 120 inserted therein for cutting a frozen nut and/or bolt. Initially, as shown in FIG. 14, pad 124 is positioned to abut or press against the side of toilet 150 for stabilization. Further, initially cutting wheel 104 is in its first longitudinal position as shown in FIG. 14 in which cutting wheel 104 is longitudinally aligned with pad 124. Since pad 124 is positioned against the base of the toilet (rather than around nut 154 such as wrench head 116 described with respect to FIG. 10A), tool 100 with bumper attachment 120 is positioned relatively lower with respect to toilet 150 and cutting wheel 104 is positioned to cut frozen nut 154.

Once positioned as desired, cutting wheel 104 is longitudinally advanced relative to bumper attachment 120 in order to cut the frozen nut 154 and/or bolt 152. More particularly, trigger 106 is pressed to engage or activate the power to motor 126, causing cutting wheel 104 to spin. Tool 100 including cutting wheel 104 is then longitudinally advanced relative to bumper attachment 120 as indicated by directional arrow 1456 in order to cut the frozen nut 154 and/or bolt 152. Stated another way, while pad 124 is positioned against the base of the toilet, tool 100 is slid over or moved relative to shaft 122 in order to advance cutting wheel 104 towards the frozen nut 154 and/or bolt 152. Cutting wheel 104 is longitudinally advanced until it cuts the frozen nut 154 and/or bolt 152. Although the method of use described herein include activating or engaging motor 126 prior to advancement to cutting wheel 104, it will be obvious to one of ordinary skill in the art that cutting wheel 104 may be longitudinally advanced to a certain extent, i.e., advanced until cutting wheel 126 abuts against the frozen nut 154, prior to activating or engaging motor 126 via trigger 106.

After the frozen nut 154 and/or bolt 152 is cut, cutting wheel 104 returns to its first longitudinal position. More particularly, after the frozen nut 154 and/or bolt 152 is cut, the user removes the force applied to housing 102 and spring 146 of tool 100 is configured to retract tool 100 (and cutting wheel 104) backwards. Cutting wheel 104 is thus returned to its first longitudinal position in which cutting wheel 104 is longitudinally aligned with pad 124 of bumper attachment 120.

FIG. 15 is a sectional side view of a tool according to another embodiment hereof. In the embodiments described above, tool 100 slides or is longitudinally advanced over the shaft of the attachment, i.e., shaft 114 of wrench attachment 112 or shaft 122 of bumper attachment 120. Conversely, in the embodiment of FIG. 15, tool 1500 includes a slide assembly 1560 disposed within a housing 1502 of tool 1500. A cutting wheel 1504 is attached to the slide assembly, and the cutting wheel is configured to be longitudinally advanced forward or retracted backward in conjunction with slide assembly 1560. Housing 1502 is formed with sufficient space to allow for sliding motion of slide assembly 1560, or alternatively may be formed with an extendible portion (not shown).

More particularly, housing 1502 contains the internal components of tool 1500, including a motor 1526, a power source 1528, and slide assembly 1560. Power source 1528 is coupled to motor 1526 in order to provide power thereto. Motor 1526 is coupled to slide assembly 1560 via male and female telescoping shafts 1562, 1564 and slide assembly 1560 is coupled to cutting wheel 1504 via a shaft 1538. More particularly, male telescoping shaft 1562 is slidingly disposed within female telescoping shaft 1564. A first end 1563 of male telescoping shaft 1562 is attached to motor 1526, while a second end (obscured from view in FIG. 15) of male telescoping shaft 1562 is disposed within female telescoping shaft 1564. A first end 1565 of female telescoping shaft 1564 is disposed over male telescoping shaft 1562, while a second end 1567 of female telescoping shaft 1564 is attached to slide assembly 1560. Relative motion between telescoping shafts 1562, 1564 allow slide assembly 1560 to longitudinally move or translate within housing 1502. However, although telescoping shafts 1562, 1564 are slidable with respect to each other, the telescoping shafts are disposed adjacent to each other with sufficient proximity such that rotation of male telescoping shaft 1562 causes rotation of female telescoping shaft 1564. As such, male telescoping shaft 1562 is configured to transfer spinning motion from motor 1526 to female telescoping shaft 1564.

Slide assembly 1560 includes a secondary or internal housing 1566, which houses a gear assembly 1530. Gear assembly 1530 includes a first gear 1532 coupled to female telescoping shaft 1564 and a second gear 1534 coupled to cutting wheel 1504 via shaft 1538. First and second gears 1532, 1534 are disposed at a 90 degree angle relative to each other and are configured to transfer the spinning motion of female telescoping shaft 1564 (from motor 1526) to cutting wheel 1504 (via shaft 1538) such that motor 1526 drives or spins cutting wheel 1504.

Tool 1500 also includes a button 1568 attached to slide assembly 1560, and thus coupled to cutting wheel 1504. Button 1568 extends outside of housing 1502 via an opening 1570 in order to be accessible to a user. Button 1568 and slide assembly 1560 attached thereto is configured to be manually longitudinally advanced and/or retracted in order to advance or retract cutting wheel 1504. Thus, cutting wheel 1504 is configured to be moved in a longitudinal direction by sliding button 1568 relative to housing 1502. When a wrench attachment 1512 is disposed within a slot 1510 of housing 1502, cutting wheel 1504 is configured to be longitudinally moved towards a wrench head 1516 of wrench attachment 1512 similar to as described with respect to tool 100. A spring 1546 is disposed within housing 1502 and coupled to button 1568. Spring 1546 is similar to spring 146 and is configured to return cutting wheel 1504 to the first longitudinal position when no force is applied to button 1568/tool 1500. More particularly, as button 1568 is pushed forward in order to advance slide assembly 1560 and cutting wheel 1504, spring 1546 is stretched. When button 1568 is released by the user, spring 1546 returns to its relaxed or normal configuration in which it is no longer stretched and thereby retracts slide assembly 1560 (and cutting wheel 1504) backwards.

In addition to sliding cutting wheel 1504, in this embodiment button 1568 also functions to activate motor 1526 which drives cutting wheel 1504 as explained above. Button 1568 is electrically coupled via one or more wires 1572 to motor 1526 and power source 1528 as will be understood by one of ordinary skill in the art in order for button 1568 to selectively engage motor 1526 when manually pressed by a user. Thus, in operation, button 1568 is simultaneously pressed down to activate motor 1526 and pushed forward to advance cutting wheel 1504. In another embodiment (not shown), a trigger similar to trigger 106 may be included for activating motor 1526 while a button similar to button 1568 is included for controlling longitudinal movement of cutting wheel 1504.

Although described herein as a wrench attachment, in another embodiment hereof, a ratchet attachment (not shown) may alternatively and/or additionally be configured for use with tool 100 or tool 1500. The ratchet attachment may include a ratchet head or socket that in a first configuration is configured to tighten a nut and in a second configuration is configured to loosen the nut. In order to alternate between the first and second configurations of the ratchet head or socket, the ratchet attachment is flipped over or rotated 180 degrees around the axis along the shaft of the ratchet attachment as will be understood by one of ordinary skill in the art.

While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. An apparatus for trimming a bolt protruding through a nut, the apparatus comprising:
a housing, wherein the housing includes a longitudinal axis;
a motor disposed within the housing;
a cutting wheel for trimming the bolt, the cutting wheel being disposed external to the housing and being coupled to the motor, wherein the cutting wheel is disposed within a first plane parallel to the longitudinal axis of the housing and is disposed at a first longitudinal position; and
a wrench attachment removably coupled to the housing, wherein when coupled to the housing the wrench attachment is disposed within a second plane spaced from the first plane and a wrench head of the wrench attachment is disposed at a second longitudinal position that is further away from the housing than the first longitudinal position such that the wrench head of the wrench attachment is longitudinally offset from the cutting wheel,
wherein when the wrench attachment is coupled to the housing, the cutting wheel is configured to be longitudinally moved relative to the wrench attachment toward the wrench head.

2. The apparatus of claim 1, wherein the first and second planes are parallel planes.

3. The apparatus of claim 2, wherein the first and second planes are spaced apart a predetermined distance that is configured such that the cutting wheel trims the bolt to a predetermined height above the nut.

4. The apparatus of claim 1, wherein when coupled to the housing, a shaft of the wrench attachment is disposed within a slot of the housing, the slot being sized to receive the shaft of the wrench attachment.

5. The apparatus of claim 4, further comprising:
a bumper attachment removably coupled to the housing, the bumper attachment being interchangeable with the wrench attachment, wherein when coupled to the housing, a shaft of the bumper attachment is disposed within the slot of the housing, the bumper attachment is disposed within the second plane, and a pad of the bumper attachment is disposed at the first longitudinal position.

6. The apparatus of claim 5, wherein the pad is configured to abut against a base of a toilet.

7. The apparatus of claim 4, wherein the slot is located within an attachment receiving portion of the housing and a spring is disposed within the slot, the spring being configured to return the cutting wheel to the first longitudinal position when no force is applied to the apparatus.

8. The apparatus of claim 7, wherein the cutting wheel is configured to be longitudinally moved toward the wrench head of the wrench attachment by sliding the housing over the shaft of the wrench attachment, thereby compressing the spring.

9. The apparatus of claim 1, further comprising:
a button coupled to the cutting wheel and extending out of an opening formed within the housing, wherein the cutting wheel is configured to be longitudinally moved toward the wrench head of the wrench attachment by sliding the button relative to the housing.

10. The apparatus of claim 9, wherein a spring is disposed within the housing and coupled to the button, the spring being configured to return the cutting wheel to the first longitudinal position when no force is applied to the button.

11. The apparatus of claim 1, further comprising:
a power source disposed within the housing and coupled to the motor.

12. The apparatus of claim 1, wherein the cutting wheel includes a cutting edge that extends around the circumference thereof.

13. The apparatus of claim 1, further comprising:
a first gear disposed within the housing and coupled to the motor; and
a second gear disposed within the housing and coupled to the cutting wheel, wherein the first and second gears are disposed at a 90 degree angle relative to each other.

14. The apparatus of claim 1, further comprising:
a trigger switch disposed within the housing and coupled to the motor, the trigger switch being configured to selectively engage the motor.

15. An apparatus for trimming a bolt protruding through a nut, the apparatus comprising:
a housing, wherein the housing includes a longitudinal axis;
a motor disposed within the housing;
a cutting wheel for trimming the bolt, the cutting wheel being disposed external to the housing and being coupled to the motor, wherein the cutting wheel is disposed within a first plane parallel to the longitudinal axis of the housing and is disposed at a first longitudinal position;
a wrench attachment removably coupled to the housing, wherein when coupled to the housing the wrench attachment is disposed within a second plane spaced from the first plane and a wrench head of the wrench attachment is disposed at a second longitudinal position that is further away from the housing than the first longitudinal position such that the wrench head of the wrench attachment is longitudinally offset from the cutting wheel; and
a bumper attachment removably coupled to the housing, the bumper attachment being interchangeable with the wrench attachment and including a pad configured to abut against a base of a toilet, wherein when coupled to the housing the bumper attachment is disposed within the second plane and the pad of the bumper attachment is disposed at the first longitudinal position,
wherein when one of the wrench attachment or the bumper attachment is coupled to the housing, the cutting wheel is configured to be longitudinally moved relative to the wrench attachment or the bumper attachment coupled to the housing.

16. The apparatus of claim 15, wherein when coupled to the housing, a shaft of the wrench attachment or a shaft of the bumper assembly is disposed within a slot of the housing, the slot being located within an attachment receiving portion of the housing and a spring being disposed within the slot, the spring being configured to return the cutting wheel to the first longitudinal position when no force is applied to the apparatus such that the cutting wheel is configured to be longitudinally moved toward the wrench head of the wrench attachment by sliding the housing over the shaft of the wrench attachment, thereby compressing the spring.

17. The apparatus of claim 15, further comprising:
a button coupled to the cutting wheel and extending out of an opening formed within the housing, wherein the cutting wheel is configured to be longitudinally moved toward the wrench head of the wrench attachment by sliding the button relative to the housing and wherein a spring is disposed within the housing and coupled to the button, the spring being configured to return the cutting wheel to the first longitudinal position when no force is applied to the button.

18. An apparatus for trimming a bolt protruding through a nut, the apparatus comprising:
a housing, wherein the housing includes a longitudinal axis;
a motor disposed within the housing;
a cutting wheel for trimming the bolt, the cutting wheel being disposed external to the housing and being coupled to the motor, wherein the cutting wheel is disposed within a first plane parallel to the longitudinal axis of the housing and is disposed at a first longitudinal position; and
a wrench attachment removably coupled to the housing, wherein when coupled to the housing the wrench attachment is disposed within a second plane spaced from the first plane and a wrench head of the wrench attachment is disposed at a second longitudinal position that is further away from the housing than the first longitudinal position such that the wrench head of the wrench attachment is longitudinally offset from the cutting wheel,
wherein when coupled to the housing, a shaft of the wrench attachment is disposed within a slot located within an attachment receiving portion of the housing, the slot being sized to receive the shaft of the wrench attachment and a spring being disposed within the slot, and
wherein when the wrench attachment is coupled to the housing, the cutting wheel is configured to be longitudinally moved relative to the wrench attachment toward the wrench head by sliding the housing over the shaft of the wrench attachment, thereby compressing the spring, the spring being configured to return the cutting wheel to the first longitudinal position when no force is applied to the apparatus.

19. The apparatus of claim 18, further comprising:
a bumper attachment removably coupled to the housing, the bumper attachment being interchangeable with the wrench attachment, wherein when coupled to the housing, a shaft of the bumper attachment is disposed within the slot of the housing, the bumper attachment is disposed within the second plane, and a pad of the bumper attachment is disposed at the first longitudinal position.

20. The apparatus of claim 18, wherein the first and second planes are parallel planes and the first and second planes are spaced apart a predetermined distance that is configured such that the cutting wheel trims the bolt to a predetermined height above the nut.
